(19) United States
(12) Patent Application Publication
(10) Pub. No.: US 2002/0179433 A1
(43) Pub. Date: Dec. 5, 2002

(54) Pulsed electrolytic cell

(76) Inventor: Irving I. Dardik, Califon, NJ (US)

Correspondence Address: FISH & NEAVE, 1251 AVENUE OF THE AMERICAS, 50TH FLOOR, NEW YORK, NY, 10020-1105, US

(21) Appl. No.: 10/161,158

(22) Filed: May 30, 2002

Related U.S. Application Data
(60) Provisional application No. 60/294,537, filed on May 30, 2001.

(51) Int. Cl. B23H 3/02; C25C 3/16

(52) U.S. Cl. 204/229.4; 204/228.1

(57) ABSTRACT

A low energy nuclear reaction power generator provided with an electrolytic cell containing an electrically-conductive heavy or light water electrolyte in which is immersed an electrode pair whose anode is formed of platinum and whose cathode is formed of palladium. Applied across these electrodes is a train of voltage pulse packets, each comprised of a cluster of pulses. The amplitude and duration of each pulse in the packet, the duration of the intervals between pulses, and the duration of the intervals between successive packets in the train are in a predetermined pattern in accordance with superlooping waves in which each wave is modulated by waves of different frequency. Each packet of voltage pulses gives rise to a surge of current in the electrolyte which flows between the electrodes and causes the heavy or light water to decompose, oxygen being released at the platinum electrode while deuterium ions migrate toward the palladium electrode. The successive surges of ions produced by the train of pulse packets bombard the palladium electrode, to bring about dense ion packing which results in fusion and heat.

### CROSS-REFERENCE TO RELATED APPLICATION

This claims the benefit of copending, commonly-assigned U.S. Provisional Patent Application No. 60/294,537, filed May 30, 2001.

### BACKGROUND OF THE INVENTION

1. Field of Invention

This invention relates generally to the use of electrolytic cells for the creation of nuclear fusion and more particularly to a low energy nuclear reaction power generator that includes an electrolytic cell across whose anode and cathode electrodes electrical pulses are applied in a predetermined pattern conducive to fusion.

2. States of Prior Art

The quest for nuclear fusion to provide an inexhaustible, non-polluting source of energy seeks to exploit the phenomena of nuclear physics. It is known that when two nuclei, for example, of deuterium (heavy hydrogen), fuse together, the combined mass of the fusion product is less, by a minute quantity, than the tiny mass of the original particles. The conversion of this tiny mass to a fusion product releases an incredible amount of energy. Energy, as expressed in the classic Einstein equation, is equal to mass multiplied by the square of the speed of light; hence the minute mass yields an enormous amount of energy.

It was Edward Teller, the atomic physicist, who in 1942 when an atom bomb had yet to be built, advanced the proposition that is the bedrock of nuclear fusion. Teller theorized that if deuterium nuclei were plunged into the fiery furnace having a temperature of many million degrees Fahrenheit created by an atomic fission reaction, the colliding nuclei would fuse in this environment and thereby liberate an incredible amount of energy. With the hydrogen bomb, Teller's theory became a reality.

Deuterons are positively charged particles and, therefore, repel each other. The closer deuterons approach each other, the stronger their repulsion and the greater the energy it takes to overcome this repulsion. When the force of the repulsion reaches its maximum value, it then creates what is known as the Coulomb barrier. It is only when this barrier is penetrated and the deuterons are brought to one ten-trillionth of a centimeter next to each other, that a strong nuclear force takes over and the particles then fuse. This is the same nuclear force that prevents nuclei which include positively-charged protons from flying apart. Fusion also occurs with tritium nuclei, for tritium is a heavy isotope of hydrogen, but its nucleus has a proton and two neutrons, whereas a deuterium nucleus has a proton and a single neutron.

Thermonuclear fusion will occur when deuterons are combined at a high enough density and a high enough temperature for a time period sufficient to effect fusion. The center of the sun affords conditions conducive to thermonuclear fusion, for this fiery center is subjected to enormous gravitational forces and is at a temperature of about 10 million degrees Fahrenheit. On earth, the gravitational forces are much weaker and it therefore takes a much higher temperature, in the order of 100 million degrees Fahrenheit, to produce a deuterium-tritium (D-T) fusion reaction. The D-T thermonuclear reaction is the one currently being pursued, for it yields more energy than D-D fusion.

Following Teller's invention of the hydrogen bomb, billions of dollars have been spent over the last 40 years toward contriving devices adapted to force heavy hydrogen nuclei to fuse together under controlled conditions and thereby liberate more energy than was expended to confine and heat the nuclei. One such device of enormous size is known as a Tokomak within whose toroidal interior powerful magnetic fields confine and squeeze hot plasma, causing deuterium and tritium ions to fuse together.

Hot fusion overcomes the Coulomb barrier by ripping off atoms from the two heavy forms of hydrogen at extremely high temperatures to create a cloud of ions or plasma. Huge magnets produce the magnetic fields to hold the plasma together for a time sufficient for some of the nuclei to crash into each other and fuse. This thermonuclear fusion reaction produces tritium and helium nuclei as well as a shower of neutrons and gamma radiation.

In a super-giant laser fusion generator, laser beams bombard a deuterium-tritium fuel pellet, causing its outer layer to vaporize and dissipate outwardly from the pellet. The resultant reaction force implodes the fuel to effect fusion. Yet despite the multi-billion dollar investments made in developing thermonuclear fusion reactors to produce energy, no such generator is at present a practical reality, and whether it ever will be, cannot be forecast. Other technologically simpler and less expensive techniques for fusing nuclei are desirable.

In the past decade or so, electrochemical techniques have been investigated as a possible technique for fusing nuclei for power generation. The investigations typically utilize an electrolytic cell whose electrolyte is heavy water that is water in which deuterium takes the place of ordinary hydrogen. The heavy water is rendered electrically conductive by a salt dissolved therein; i.e., lithium deuterhydroxide. Immersed in this electrolyte is an anode-cathode electrode pair composed of a strip of metal (such as palladium) surrounded by a coil of similar or another metal (such as platinum wire).

When a d-c voltage is impressed across these electrodes, the resultant current flow in the heavy water causes it to decompose into its constituent elements. As a consequence, oxygen is released as a gas at the platinum electrode, while deuterium ions migrate toward the palladium electrode. The buildup of a large concentration of these ions in the palladium metal is thought to initiate a low energy nuclear reaction. The energy released by such an low energy reaction could be captured by the atomic lattice of the electrode and show up as heat.

In 1989, Martin Fleischmann and Stanley Pons, on observing excess heat generation in an electrochemical cell, claimed they had observed evidence of room temperature fusion of deuterium ions. It is now generally understood that their observations were not that of deuterium-deuterium fusion but of some other phenomena. Further electrochemistry studies by E. Storms, G. H. Miley and others, suggest that the phenomena involved is an anomalous nuclear process in the solid electrode. The excess heat generation may be attributed to the fusion of hydrogen or isotopic hydrogen nuclei with the nuclei of the solid electrode material rather than of the fusion of hydrogenic nuclei themselves. The amount of excess heat generated appears to depend on the nature of the voltage applied to the electrodes and on whether the resultant current flowing through the electrolyte is steady or pulsed.

In any case, present day electrochemical cells do not generate enough excess heat to be commercially viable power sources. Further improvements in electrochemical cell design and methods of operation are desirable.

### SUMMARY OF INVENTION

The main object of this invention is to provide a low energy nuclear reaction power generator that includes a cell having a pair of electrodes immersed in an electrically-conductive heavy or light water electrolyte, to which electrodes electrical pulses are applied which are in a predetermined pattern.

The significant feature of the present invention which distinguishes it from a prior cell in which the current through the electrolyte is pulsed, is that in a cell in accordance with the invention, pulsing takes place in a pulse pattern that is highly conducive to fusion.

More specifically, an object of this invention is to provide a low energy nuclear reaction power generator that yields far more energy in the form of heat than is applied to the cell in the form of electricity.

Briefly stated, these objects are attained in a low energy nuclear reaction power generator provided with an electrolytic cell containing an electrically-conductive electrolyte in which is immersed a metallic electrode pair whose anode and cathode are formed of platinum, palladium, titanium, nickel or any other suitable metal. The electrolyte may be any suitable fluid such as light water, heavy water, and liquid metals, etc. or may also be a suitable solid material—e.g., a semiconductor. Applied across these electrodes is a train of voltage pulse packets, each comprised of a cluster of pulses.

The amplitude and duration of each pulse in the packet, the duration of the intervals between pulses, and the duration of the intervals between successive packets in the train are in a predetermined pattern in accordance with superlooping waves in which each wave is modulated by waves of different frequency. Each packet of voltage pulses gives rise to a surge of current in the electrolyte which flows between the electrodes and causes the electrolyte (e.g., heavy or light water) to decompose, oxygen being released, for example, at the platinum electrode while hydrogen (or isotopic hydrogen, e.g., deuterium) ions migrate toward, for example, the palladium electrode. The successive surges of ions produced by the train of pulse packets bombard the metallic electrode to bring about dense ion packing. The dense ion packing preferably causes fusion which results in the generation of energy in the form of heat. The energy generated in the heat is greater than the energy of the voltage pulses applied to the electrodes.

It should be noted that the dense ion packing may substantially increase the resistivity—i.e., the measure of a material's ability to oppose the flow of an electric current—of the metallic electrode by introducing hydrogen, or other, ions to the structure of the metal. This resistivity preferably can be measured in real-time by passing a current through the metallic electrode and measuring the change in current over time. The measured current over time is an indication of the change in resistivity, and, hence, the level of ion packing of the metallic electrode over time. Thus, a real time indicator of the ion packing may then be realized by continually passing a current through the metallic electrode and measuring the current.

### BRIEF DESCRIPTION OF DRAWING

For a better understanding of the invention as well as other objects and features thereof, reference is made to the following detailed description to be read in conjunction with the annexed drawings wherein:

FIG. 1 schematically illustrates superlooping wave phenomena.

FIG. 2 schematically illustrates a low energy nuclear reaction electrolytic cell in accordance with the invention;

FIG. 3 illustrates the pattern of electrical pulses applied to the electrodes of the cell; and

FIG. 4 illustrates the pattern of electrical pulses applied to the electrodes of the cell with pulse packets switched off during relaxation periods.

### DETAILED DESCRIPTION OF INVENTION

Superlooping:

The present invention represents a significant advance beyond the discovery at the Los Alamos National Laboratory that a greater production of excess heat is obtained in an electrochemical cell by pulsing the current flowing through the cell. In the present invention, applied to the electrodes of the cell are voltage pulses to produce a pulsed current flow in the cell. However, these pulses are not of constant amplitude and duration but are in a pattern in which the amplitude and duration of the pulses and the intervals therebetween are modulated to give rise to a dense packing, for example, of deuterium ions in the palladium electrode that promotes a fusion reaction.

This pulse pattern is in accordance with superlooping activity as set forth in the theory advanced in the Irving I. Dardik article “The Great Law of the Universe” that appeared in the March/April 1994 issue of the “Cycles” Journal. This article is incorporated herein by reference.

As pointed out in the Dardik article, it is generally accepted in science that all things in nature are composed of atoms that move around in perpetual motion, the atoms attracting each other when they are a little distance apart and repelling upon being squeezed into one another. In contradistinction, the Dardik hypothesis is that all things in the universe are composed of waves that wave, this activity being referred to as “superlooping.” Superlooping gives rise to and is matter in motion; i.e., both change simultaneously to define matter-space-time.

Thus in nature, changes in the frequency and amplitude of a wave are not independent and different from one another, but are concurrently one and the same, representing two different hierarchical levels simultaneously. Any increase in wave frequency at the same time creates a new wave pattern, for all waves incorporate therein smaller waves and varying frequencies, and one cannot exist without the other.

Every wave necessarily incorporates smaller waves, and is contained by larger waves. Thus each high-amplitude low-frequency major wave is modulated by many higher frequency low-amplitude minor waves. Superlooping is an ongoing process of waves waving within one another.

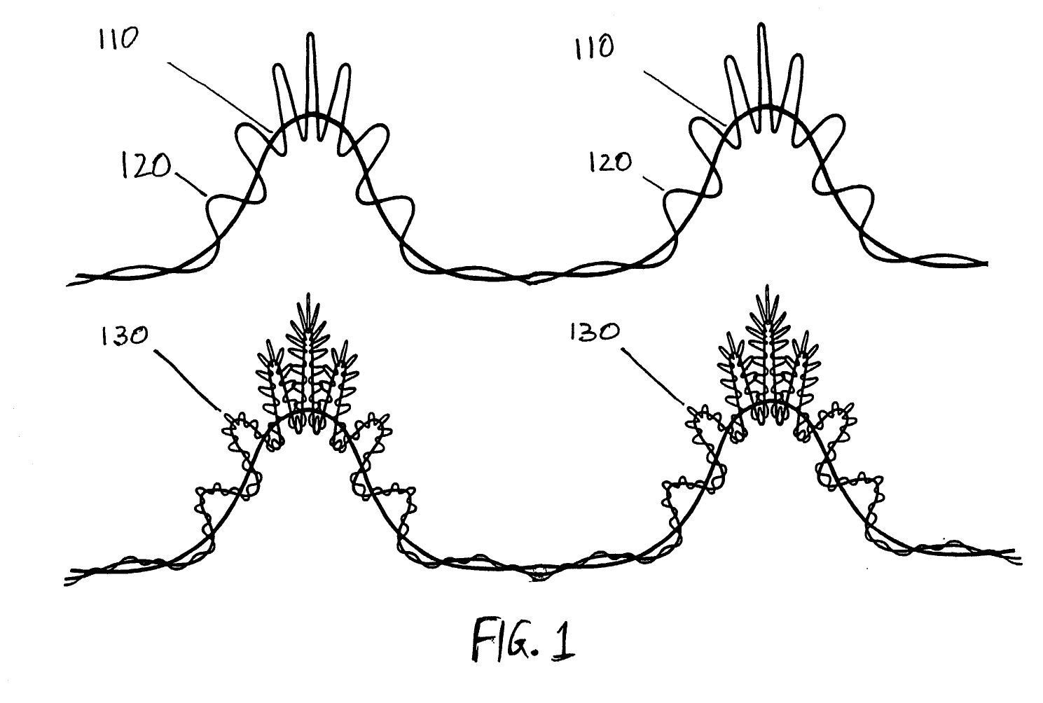

FIG. 1 (adapted from the illustrations in the Dardik article) schematically illustrates superlooping wave phenomena. FIG. 1 depicts low-frequency major wave 110 modulated, for example, by minor waves 120 and 130. Minor waves 120 and 130 have progressively higher frequencies (compared to major wave 110). Other minor waves of even higher frequency may modulate major wave 110, but are not shown for clarity.

This new principle of waves waving demonstrates that wave frequency and wave intensity (amplitude squared) are simultaneous and continuous. The two different kinds of energy, i.e., energy carried by the waves that is proportional to their frequency, and energy proportional to their intensity are also simultaneous and continuous. Energy therefore is waves waving, or “wave/energy.” In a low energy nuclear reaction power generator in accordance with the invention, the pattern of pulses applied to the electrodes of the cell is derived from super-looping wave activity.

The Low Energy Nuclear Reaction Power Generator:

Referring now to FIG. 2, there is shown one preferable embodiment of a low energy nuclear reaction power generator in accordance with the invention provided with an electrolyte cell having a vessel 10. Vessel 10 contains electrolyte 11. Electrolyte 11 may be any suitable liquid electrolyte, such as heavy water, light water, molten metals, etc. For purposes of illustration, electrolyte 11 may, for example, be heavy water which is rendered electrically conductive by a suitable salt dissolved therein.

Immersed in the electrolyte is an anode-cathode electrode pair formed by a cathode 12 and an anode 13. Cathode 12 and anode 13 may be made of any suitable metal such as palladium, platinum, titanium, nickel, etc. For purposes of illustration, cathode 12 may, for example, be a strip of palladium and anode 13 may, for example, be a coil of platinum. Anode coil 13 surrounds the strip of palladium metal so that the electrodes are bridged by the conductive electrolyte 11 and a voltage impressed across the electrodes causes a current to flow therebetween.

Connected across the electrodes of the electrochemical cell is a low-voltage battery, resulting in a steady current flowing through the heavy or light water electrolyte, causing it to decompose, so that oxygen gas is liberated at the platinum anode electrode while hydrogenic ions migrate toward the palladium cathode electrode and accumulate thereon.

In a generator in accordance with the invention, a d-c voltage source 14 is provided whose output is applied across the electrodes 12 and 13 of the cell through an electronic modulator 14 whose operation is controlled by a programmed computer 16, whereby the modulator yields voltage pulses whose amplitude and duration as well as the duration of the intervals between pulses are determined by the program. The maximum amplitude of the pulses corresponds to the full output of the d-c source 14. Thus if the source provides a 45 VDC output, the maximum amplitude of the pulses will be 45 VDC, and the amplitudes of pulses having a lesser amplitude will be more or less below 45 VDC, depending on the program.

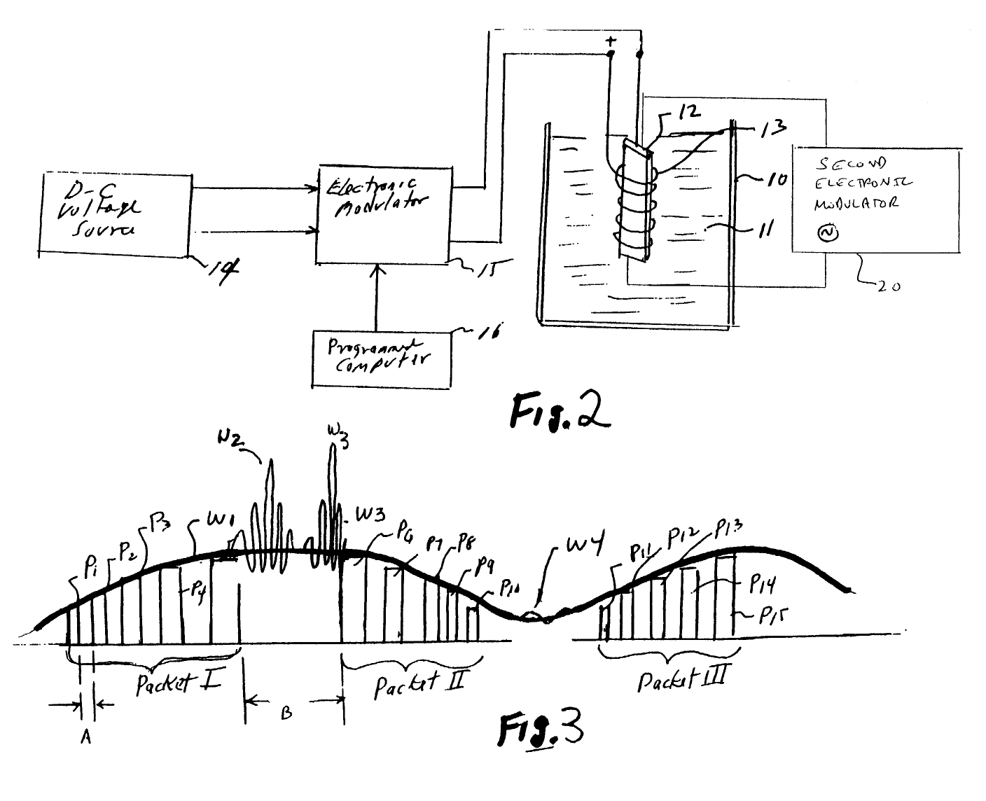

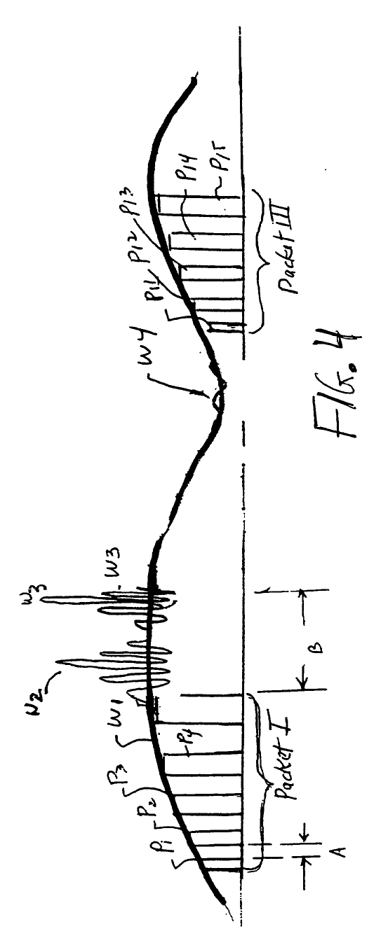

Computer 16 is programmed to activate electronic modulator 15 so as to yield a train of pulse packets, each packet being formed by a cluster of pulses that assume the pattern shown in FIG. 3. Thus the first packet in the train, Packet I, is composed of five pulses P1 to P₅ which progressively vary in amplitude, pulse P1 being of the lowest amplitude and pulse P₅ being of the highest amplitude. The respective durations of pulses P1 to P₅, vary progressively, so that pulse P1 is of the shortest duration and pulse P₅ is of the longest duration. And the intervals A between successive pulses in the cluster forming the packet vary progressively in duration. Thus the first interval between pulses P₄ and P₅ is shortest in duration, and the last interval between pulses P4 and P5 is longest in duration. While the packets are shown as being composed of five pulses, in practice they may have a fewer or a greater number of pulses. The duration of a packet may in practice be about thirty seconds, and the intervals between successive packets may be in a range of two to five seconds.

The second packet in the train, Packet II, is also composed of five pulses P₆ to P₁₀, but their amplitudes and durations, and the intervals between pulses are the reverse of those in the pulse cluster of Packet I. Hence pulse P₆ is of the greatest amplitude and that of P₁₀ of the lowest amplitude.

The third packet in the train, Packet III, is formed of a cluster of five pulses P₁₁ to P₁₅ whose amplitudes and durations, and the intervals between pulses correspond to those in Packet I. The intervals between successive packets in the train have a duration B that changes from packet to packet.

The varying amplitudes of the pulses in the successive packets conform to the amplitude envelope of a major wave W₁. The varying durations of the pulses in the packets conform to the amplitude envelope of a minor wave W₂ whose frequency differs from that of major wave W₁. The varying durations of the intervals between the pulses in a packet conforms to the amplitude envelope of still another minor wave W₃ of different frequency. And the varying durations of the intervals between successive packets in the train are in accordance with the amplitude envelope of yet another minor wave W₄ of different frequency.

A second modulator 20 may be implemented in order to measure the resistivity of cathode 12. Preferably, second modulator 20 may generate an AC current and pass the AC current through cathode 12. This AC current is preferably at a different frequency than the pulses produced by electronic modulator 15. In this way, no substantial interference exists between the pulses produced by modulator 15 and the current produced by second modulator 20.

In the proposed configuration shown in FIG. 3, the current provided by modulator 20 may be used to measure the resistivity of cathode 12. This measurement may be obtained by passing an AC current, which may be substantially constant—i.e., the amplitude of the peaks and valleys of the current and the frequency of the current are substantially constant—, through cathode 12 while measuring the voltage potential across the cathode. The change in voltage potential reflects the change in resistivity based on the relationship V(voltage)=I(current)*R(resistance). The known resistivity change may then be used to indicate the level of ion packing of the cathode. As described above, ion packing may be a necessary precursor for the success of low energy nuclear reactions in a cell according to the invention.

It will be understood that in FIG. 3 for purposes of clarity only small portions of minor waves W2, W3 and W4 superimposed on wave W1 are shown. Further for clarity, the amplitudes and frequencies of superlooping minor waves W2, W3, and W4, relative to each other and relative to major wave W1, are not drawn to scale. In fact the maximum amplitude of the minor waves may be proportional to the instantaneous amplitude of the major wave. Thus, minor waves W2 and W3 (which are located at about the peak amplitude of major wave W1) are likely to have much larger maximum amplitudes than the maximum amplitude of minor wave W4 (which is located at about the bottom of a valley in wave W1). The maximum amplitude of minor waves W2 and W3 at the peak of the major wave may even be comparable to the peak amplitude of major wave W1, i.e., the minor waves may have the same intensity as the major waves as shown in FIG. 1. Other illustrative examples of superlooping minor waves within major waves and their frequency and amplitude distribution are provided by the FIGS. shown in the Dardik article “The Great Law of the Universe” incorporated herein by reference.

With continued reference to FIG. 3, the pattern of the voltage pulses which constitute the train is governed by superlooping waves W₁ to W₄ and the current which flows between the electrodes immersed in the electrolyte is pulsed accordingly.

Thus instead of a steady stream of deuterium ions migrating toward the palladium electrode, the deuterium ions travel in clusters, each created by a packet of pulses, to produce a high intensity surge of deuterium ions that bombards the palladium electrode. The surges of deuterium ions which repeatedly bombard the palladium electrode give rise to a dense packing of these ions on the palladium and fuse thereon to produce heat.

Highly effective computer pulse pattern programs afford optimum results, resulting in the greatest amount of fusion heat at the palladium electrode. These can be determined empirically by modifying the program to find the most effective pattern.

One example of the most effective pulse pattern is to incorporate a relaxation period corresponding to the downward phases of the major wave W1. Pulse packets in the pulse train may be completely turned off during the relaxation periods corresponding to the downward phases. FIG. 4. illustrates a pulse pattern with pulses (e.g., packet P2, FIG. 3) completely switched off during the relaxation period.

The program is developed from a formation of superlooping waves which are digitized so as to derive a pulse at the peak of each wave cycle. The aforementioned Dardik article illustrates various forms of superlooping waves.

While there has been shown a preferred embodiment of a low energy nuclear reaction power generator, it is to be understood that many changes may be made therein without departing from the spirit of the invention. Thus one may use a silicon instead of platinum wire. And the electrode pair may be formed by concentric tubes, rather than by a strip surrounded by a coil as illustrated in FIG. 2.

I claim:

1. An apparatus for increasing the resistivity of a metal, the apparatus comprising:
A. an electrolytic cell containing an electrically conductive water electrolyte having immersed therein an anode-cathode pair, the cathode being formed of the metal; and
B. Means applying across the electrodes a train of pulse voltage packets each comprised of a cluster of pulses, to cause a correspondingly pulsed current to flow between the electrodes, causing the water to decompose whereby oxygen is released at the anode electrode while hydrogenic ions migrate toward the metal electrode, each packet of pulses producing a surge of ions which bombard the palladium, successive surges producing a dense packing of ions on the metal.

2. The apparatus of claim 1, wherein the amplitude and duration of each pulse in the packet, the duration of the intervals between these pulses and the duration of the intervals between successive packets in the train are in a predetermined pattern in accordance with superlooping waves in which each wave is modulated by waves of different frequencies.

3. The apparatus of claim 1, wherein said train of pulse packets is produced by a d-c source whose output is applied to the electrodes through an electronic modulator controlled by a computer which is programmed to produce voltage pulses in said pattern.

4. The apparatus of claim 1, wherein the cathode electrode is formed by a strip of metal and said anode electrode by a coil of metallic wire surrounding the strip of metal.

5. The apparatus of claim 2, wherein each packet has at least five pulses.

6. The apparatus of claim 2, wherein each packet has a duration of about thirty seconds.

7. The apparatus of claim 2, wherein the intervals between successive packets is in a range of about two to five seconds.
